(19) United States
(12) Patent Application Publication
(10) Pub. No.: US 2026/0170576 A1
(43) Pub. Date: Jun. 18, 2026

(54) AUTOMATIC REPEATING NETWORK OPERATION EXECUTION USING PARTIAL SWITCHES

(71) Applicant: ADP, Inc., Roseland, NJ (US)

(72) Inventors: Sree BONASU, Parsippany, NJ (US); ChiaoWei LEE, Parsippany, NJ (US)

(73) Assignee: ADP, Inc., Roseland, NJ (US)

(21) Appl. No.: 18/981,052

(22) Filed: Dec. 13, 2024

(51) Int. Cl. G06Q 40/12; G06Q 40/02; G06Q 40/06

(52) U.S. Cl. CPC G06Q 40/125; G06Q 40/02; G06Q 40/06

(57) ABSTRACT

A system can receive, from a client device, a request to execute an automatic repeating network operation using a profile data structure. The system can query a database to retrieve multiple source identifiers and corresponding computing infrastructure identifiers. The system can cause the client device to present a user interface comprising an interface object for each of the source identifiers. The interface object can be configured to display configurations for the automatic repeating network operation associated with a respective source identifier. The system can receive interactions corresponding to partial switches for the automatic repeating network operation for at least two of the multiple source identifiers. The system can generate one or more executable commands to cause a payroll processing system to update the profile data structure based on the interactions. The system can execute the automatic repeating network operation in accordance with the updated profile data structure.

### TECHNICAL FIELD

This application is generally related to computing technology and, more particularly, to automatic repeating network operation execution using partial switches.

### BACKGROUND

Various systems perform network operations to facilitate the enrollment of users into direct deposit programs. As systems grow in complexity with multiple components and dependencies, efficiently and reliably managing the timing, sequencing, and execution of network operations across various systems becomes challenging. This complexity introduces risks of errors, delays, or inefficiencies.

### SUMMARY

Aspects of the technical solutions described herein address the challenges of computing systems in managing automatic repeating network operation executions across interconnected computing architectures, including processing and data management systems. In this regard, certain computing systems use intermediary processes for the transfer of information, which can lead to inefficiencies and delays. For example, limited system-to-system communication can hinder the timely propagation of information changes. Such systems use indirect configurations, such as data scraping or manual intervention, to extract and modify data, which can be resource-intensive and error-prone. These configurations may not consistently verify the successful application of the changed information. The absence of a direct confirmation pathway for execution feedback can limit the ability of systems to validate updates in real-time or near real-time. Additionally, authentication processes that rely on static credentials can create access barriers when credentials are unavailable or misconfigured. The lack of seamless integration and real-time processing capabilities can result in challenges for computing systems to efficiently execute updates to configuration data, potentially leading to delays, errors, and user inconvenience.

The technical solutions described herein address these and other technical challenges by implementing a computing architecture configured to provide secure, efficient, and direct interactions among interconnected computing systems, such as processing systems, data management systems, and other relevant computing systems. The computing architecture integrates partial switching operations to facilitate the transfer, adjustment, and configuration of information associated with data structures, such as identifiers, attributes, types, allocation parameters, and the like, across multiple data structures associated with a user profile. In this regard, the computing architecture provides a user interface that allows for direct interactions with the system. The user interface facilitates the management of various configuration operations associated with the source identifiers (e.g., multiple systems) and computing infrastructure identifiers. The computing architecture processes interactions received via the user interface in real-time or near real-time, thereby facilitating simultaneous updates or adjustments across multiple data structures. Based on the processed interactions, the computing architecture updates the user profile, such that the latest information is reflected in the system. This configuration allows for accurate and timely execution of automatic repeating network operations, enhancing the efficiency and user experience. In some aspects, the computing architecture leverages OAuth-based authentication to collect user consent and facilitate direct write-back capabilities to update system configurations. Additionally, the computing architecture implements API-based integration to allow systems to retrieve and update information using secure endpoints.

The technical solutions described herein provide enhanced data privacy measures, such as implementing tokenized session identifiers to minimize the exposure of personally identifiable information during data exchanges. Furthermore, the technical solutions provide robust authentication methods, such as phone-based proofing or one-time passcodes, to verify user identity during enrollment and modification processes. To maintain compliance and accountability, the computing architecture can be configured to track and manage individual consent records across multiple network operations, independently of centralized logins. The computing architecture supports scalable operations by allowing direct read and write capabilities for data structures, while remaining adaptable for use cases involving configuration updates, attribute adjustments, or other data management operations. The technical solutions described herein provide a scalable and robust framework for managing automatic repeating network operation executions across interconnected computing architectures.

An aspect of the technical solutions described herein is directed to a system. The system includes one or more processors coupled with memory. The system can receive, from a client device, a request to execute an automatic repeating network operation using a profile data structure associated with the client device. The system can query, using the profile data structure, a database to retrieve multiple source identifiers and corresponding computing infrastructure identifiers, where each source identifier is associated with a computing infrastructure identifier for the automatic repeating network operation. The system can cause the client device to present a user interface comprising an interface object for each of the multiple source identifiers. The interface object can be configured to display configurations for the automatic repeating network operation associated with a respective source identifier. The system can receive, from the client device, a plurality of interactions corresponding to partial switches for the automatic repeating network operation for at least two of the multiple source identifiers. The system can generate one or more executable commands to cause a payroll processing system to update the profile data structure based on the plurality of interactions. The system can execute the automatic repeating network operation in accordance with the updated profile data structure.

The profile data structure can be associated with one or more accounts maintained in the database. Each account can include a routing number and an account number associated with the corresponding computing infrastructure identifiers. Each account can be at least one of a savings account, a checking account, an investment account, or a retirement account. The system can cause, upon receiving a confirmation from the client device, the payroll processing system to update the configurations for the automatic repeating network operation. The configurations can include at least one of updating direct deposit allocations, adding or removing direct deposit accounts, or modifying direct deposit payment schedules. The system can cause, in response to receiving the plurality of interactions corresponding to the partial switches for the automatic repeating network operation, the payroll processing system to modify an allocation of direct deposit amounts to one or more accounts associated with the corresponding computing infrastructure identifiers. The system can cause the payroll processing system to allocate the direct deposit amounts based on a numerical amount or a percentage.

The system can utilize OAuth to establish secure authorization. The OAuth can cause execution of the automatic repeating network operation associated with the profile data structure. The system can generate one or more application programming interface (API) tokens configured to establish secure communication with at least one of a client device or a gateway. The system can cause each of the interface objects to present an interactive element that, when interacted with, causes the one or more processors to execute actions. The actions can include initiating the partial switches. The system can generate a session identifier to track updates to the configurations for the automatic repeating network operation. The system can execute an operation upon updating the profile data structure. The operation can include generating payment instructions for the corresponding computing infrastructure identifiers.

An aspect of the technical solutions described herein is directed to a method. The method can include receiving, from a client device, a request to execute an automatic repeating network operation using a profile data structure associated with the client device. The method can include querying, using the profile data structure, a database to retrieve multiple source identifiers and corresponding computing infrastructure information. The corresponding computing infrastructure information can include one or more electronic accounts. The method can include causing the client device to present a user interface including an interface object for each of the multiple source identifiers. The interface object can be configured to display configurations for the automatic repeating network operation associated with a respective source identifier. The method can include receiving, from the client device, a plurality of interactions corresponding to partial switches for the automatic repeating network operation for at least two of the multiple source identifiers. The method can include generating one or more executable commands to cause a payroll processing system to update the profile data structure based on the plurality of interactions. The method can include executing the automatic repeating network operation in accordance with the updated profile data structure.

Each electronic account can include a routing number and an account number associated with a corresponding computing infrastructure identifier. Each electronic account can be at least one of a savings account, a checking account, an investment account, or a retirement account. The method can include causing, upon receiving a confirmation from the client device, the payroll processing system to update the configurations for the automatic repeating network operation. The configurations can include at least one of updating direct deposit allocations, adding or removing direct deposit accounts, or modifying direct deposit payment schedules. The method can include causing, in response to receiving the plurality of interactions corresponding to the partial switches for the automatic repeating network operation, the payroll processing system to modify an allocation of direct deposit amounts to one or more electronic accounts associated with a corresponding computing infrastructure identifier. The method can include causing the payroll processing system to allocate the direct deposit amounts based on a numerical amount or a percentage. The method can include utilizing OAuth to establish secure authorization. The OAuth can cause execution of the automatic repeating network operation associated with the profile data structure.

An aspect of this disclosure can be directed to a non-transitory computer readable medium, including one or more instructions stored thereon and executable by a processor. The processor can receive, from a client device, a request to execute an automatic repeating network operation using a profile data structure associated with the client device. The request can be based on data retrieved by a gateway from data sources. The data sources can include at least one of databases, APIs, or computing infrastructures. The processor can query, based on the profile data structure and the data retrieved by the gateway, a database to retrieve multiple source identifiers and corresponding computing infrastructure identifiers. The processor can cause the client device to present a user interface comprising an interface object for each of the multiple source identifiers. The interface object can be configured to display configurations for the automatic repeating network operation associated with a respective source identifier. The processor can receive, from the client device, a plurality of interactions corresponding to partial switches for the automatic repeating network operation for at least two of the multiple source identifiers. The processor can generate one or more executable commands to cause a payroll processing system to update the profile data structure based on the plurality of interactions. The processor can execute the automatic repeating network operation in accordance with the updated profile data structure.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with some implementations.

FIG. 2 depicts an example method of automatic repeating network operation execution using partial switches, in accordance with some implementations.

FIGS. 3A-3B depict an example user interface, in accordance with some implementations.

FIG. 4 depicts a block diagram of an example computing system for implementing the embodiments of the present solution, including, for example, the system depicted in FIG. 1, and the method depicted in FIG. 2.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation. Several other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein implement automatic repeating network operation execution using a profile data structure associated with a client device. The system receives a request from the client device to execute an automatic repeating network operation (e.g., a direct deposit operation executed at regular or periodic intervals). In response to the request, the system queries a database using the profile data structure to retrieve multiple source identifiers (e.g., multiple employers) and their corresponding computing infrastructure identifiers (e.g., corresponding banking systems), where each source identifier is associated with a computing infrastructure identifier for the automatic repeating network operation. The system causes the client device to present a user interface comprising interface objects for each of the multiple source identifiers, with each interface object configured to display configurations for the automatic repeating network operation associated with its respective source identifier. The system receives a plurality of interactions from the client device corresponding to partial switches for the automatic repeating network operation for at least two of the multiple source identifiers. Based on these interactions, the system generates one or more executable commands that cause a payroll processing system to update the profile data structure with the modified configurations. The system then executes the automatic repeating network operation in accordance with the updated profile data structure. The computing architecture, thus, facilitates dynamic and accurate management of configurations across multiple source identifiers.

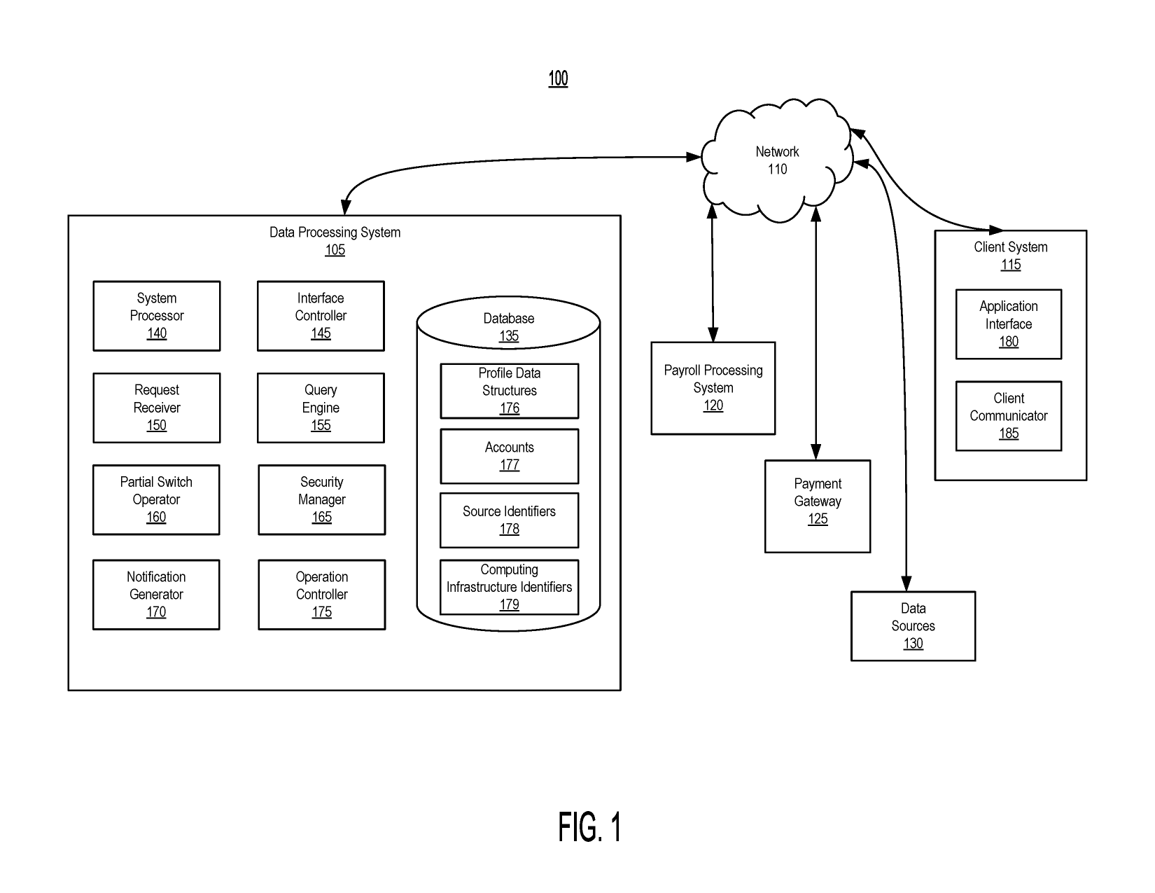

FIG. 1 depicts an example system according to one or more aspects of the technical solutions described herein. As illustrated by way of example in FIG. 1, a system 100 can include one or more of a data processing system 105, a client system 115, a payroll processing system 120, a payment gateway 125, and a data source 130. One or more components of the system 100 can communicate via network 110.

The data processing system 105 can include a physical computer system operatively coupled or couplable with one or more components of the system 100. The data processing system 105 can include, host, or be hosted by or on a cloud system, a server, a distributed remote system, or any combination thereof. The data processing system 105 can include a virtual computing system, an operating system, and a communication bus to effect communication and processing. The data processing system 105 can include physical infrastructure, such as physical servers, storage devices, and network equipment housed in data centers. The data processing system 105 can include a virtual computing system, which can include cloud-based virtual machines or containers for running applications and services. The data processing system 105 can include an operating system that can function as the core manager, allocating resources, configuring processes, and maintaining seamless interaction between hardware and applications. The data processing system 105 can include a communication bus that can facilitate communication between different components within the system. The data processing system 105 can be configured to connect with external systems to allow for data exchange and service delivery to end users.

The network 110 can include any type or form of network. The geographical scope of the network 110 can vary widely and the network 110 can include a body area network (BAN), a personal area network (PAN), a local-area network (LAN), e.g., Intranet, a metropolitan area network (MAN), a wide area network (WAN), or the Internet. The topology of the network 110 can be of any form and can include, e.g., any of the following: point-to-point, bus, star, ring, mesh, or tree. The network 110 can include an overlay network which is virtual and sits on top of one or more layers of other networks 110. The network 110 can be of any such network topology as known to those ordinarily skilled in the art capable of supporting the operations described herein. For example, the network 110 can be any form of computer network that can relay information between the data processing system 105, the client system 115, the payroll processing system 120, the payment gateway 125, and the data source 130. The network 110 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include application layer, transport layer, Internet layer (including, e.g., IPv6), or the link layer. The network 110 can include a type of a broadcast network, a telecommunications network, a data communication network, or a computer network.

The client system 115 (also referred to herein as the client device 115) can include a computing system that can be used to access the functionality of the data processing system 105, the payroll processing system 120, the payment gateway 125, or the data source 130. The client system 115 can include a smart phone, mobile device, laptop computer, desktop computer, one or more servers, or any other type of computing device. The client system 115 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 115 can include one or more devices to receive input from a user or to provide output to a user. For example, the output capabilities of the client system 115 can be presented through a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto.

Each client device 115 can be associated with an identifier used to identify devices or user profiles operating the client devices 115. The identifier can be of one or more forms, such as a device ID, which can be a code assigned to the client device 115 by the manufacturer or operating system, a MAC address, which can be a hardware address assigned to the client device’s network interface, or an IP address, which can identify the client device 115 on a network. The identifier can be a user ID associated with the user profile operating the client device 115, or a session ID, which can be a temporary identifier assigned to a specific session. Other identifiers, such as a serial number, can be used depending on the system and device configuration.

The client system 115 can execute an application that communicates with the data processing system 105 or the payment gateway 125. The application can present one or more application interfaces 180. The application interface 180 can include a set of rules or protocols that allow different software programs or systems to communicate with each other. The application interface 180 can provide user interfaces to facilitate interaction. Users can input information, view content, or initiate actions through the application interface 180. The client application can include an application executing on each client system 115. The client application can include a web application, a server application, a resource, a desktop, or a file. In some embodiments, the client application can include a local application (e.g., local to a client system 115), a hosted application, a software-as-a-service (SaaS) application, a virtual application, a mobile application, and other forms of content. In some embodiments, the client application can include or correspond to applications provided by remote servers or third-party servers.

The application interface 180 can be configured to provide an interface object for each source identifier 178 and its corresponding computing infrastructure identifier 179. The interface objects can be dynamically generated and arranged in various configurations, such as tabs, panels, or dropdown menus, depending on the user’s preferences or the operational context. Each interface object can present relevant account details, such as account numbers, account types (e.g., savings, checking), allocation percentages, or routing information. The interface object can include interactive elements, such as buttons, sliders, or dropdown menus, which allow users to modify or interact with the presented configurations. When a user interacts with an interactive element, the application interface 180, via the client device 115, can cause the data processing system 105 to execute actions. In an aspect, the actions can include initiating partial switch operations. For example, interacting with a slider to adjust allocation percentages for a specific account can trigger a partial switch operation, modifying the direct deposit allocation between accounts. Similarly, selecting a dropdown menu to update a direct deposit payment schedule can cause the data processing system 105 to generate executable commands that update the profile data structure 176.

The client system 115 can include, interface with, communicate with, or otherwise utilize a client communicator 185. The client communicator 185 within the client system 115 can be similar to, and include any of the structure and functionality of, the interface controller 145 described in connection with the data processing system 105. For example, the client communicator 185 within the client system 115 can communicate with the data processing system 105, the payroll processing system 120, the payment gateway 125, and the data source 130 via the network 110 using one or more communication interfaces to carry out the various operations described herein. The client communicator 185 can be compatible with particular content delivery systems corresponding to particular content objects, structures of data, types of data, or any combination thereof.

The data processing system 105 can include, interface with, communicate with, or otherwise utilize a database 135. The database 135 can be a computer-readable memory that can store or maintain any of the information described herein. The database 135 can store data associated with the system 100. The database 135 can include one or more hardware memory devices to store binary data, digital data, or the like. The database 135 can include one or more electrical components, electronic components, programmable electronic components, reprogrammable electronic components, integrated circuits, semiconductor devices, flip flops, arithmetic units, or the like. The database 135 can include at least one of a non-volatile memory device, a solid-state memory device, a flash memory device, or a NAND memory device. The database 135 can include one or more addressable memory regions disposed on one or more physical memory arrays. A physical memory array can include a NAND gate array disposed on, for example, at least one of a particular semiconductor device, an integrated circuit device, or a printed circuit board device. In an aspect, the database 135 can correspond to a non-transitory computer readable medium. In an aspect, the non-transitory computer readable medium can include one or more instructions executable by a system processor 140.

The database 135 can store or maintain one or more data structures, which can include containers, indices, or otherwise store each of the values, pluralities, sets, variables, vectors, numbers, or thresholds described herein. The database 135 can utilize columnar storage databases or in-memory data grids for high-speed data access and processing. The database 135 can be accessed using one or more memory addresses, index values, or identifiers of any item, structure, or region maintained in the database 135. The database 135 can be accessed by the components of the data processing system 105, the client system 115, the payroll processing system 120, the payment gateway 125, the data sources 130, or any other computing device described herein, via the network 110. The database 135 can be internal to the data processing system 105. The database 135 can exist external to the data processing system 105 and can be accessed via the network 110. For example, the database 135 can be distributed across many different computer systems (e.g., a cloud computing system) or storage elements and can be accessed via the network 110 or a suitable computer bus interface.

The database 135 can store or maintain one or more profile data structure 176. The profile data structure 176 can include a structured representation of a user or an entity. A user can refer to a customer (e.g., an account holder), a merchant (e.g., a business, vendor, or service provider), or an employee. An entity can refer to a financial institution, such as banks, credit unions, investment firms, or other providers of financial services. The profile data structure 176 can include relevant details for automatic repeating network operation. An automatic repeating network operation can refer to a process where predefined tasks or actions are executed periodically or based on specific triggers. In the context of payroll processing, an automatic repeating network operation can include recurring tasks such as updating direct deposit allocations, transferring funds between accounts, or adjusting payment schedules according to predefined rules stored in the profile data structure 176. In an aspect, the automatic repeating network operation can include associating new payment sources, such as employer accounts, or new payment methods, such as credit cards or digital wallets, with the profile data structure 176.

The profile data structure 176 associated with a user profile can include personal details (name, address), employment information (job title, hire date, department), compensation data (salary, bonuses, or contribution allocations), tax details (withholdings, filing status), or banking information, among other attributes. The profile data structure 176 can include attributes with specific data types, such as numeric values for salary, string types for account numbers, and Boolean values for account status. The profile data structure 176 can organize entities in a hierarchical structure, where one entity acts as a parent to multiple child entities (e.g., a company or an employer profile having a hierarchical relationship with department profiles, and department profiles having hierarchical relationships with employee profiles). The profile data structure 176 can include metadata such as creation date, modification timestamps, data source, and ownership, among others. The metadata attributes can facilitate management of compliance, contribution tracking, and updates, such that the profile data remains current and compliant with evolving standards.

Each profile data structure 176 can be associated with accounts 177, which can include or be electronic accounts. The accounts 177 can be stored or maintained in the database 135. The accounts 177 correspond to or include relevant digital records that contribute to the profile of the user or entity. The accounts 177 can include savings accounts, checking accounts, investment accounts, retirement accounts, or other financial accounts associated with a profile data structure 176. Each account can be associated with various attributes, such as a routing number, an account number, and contact information associated with the user or entity (e.g., name, address, email, phone number), among others. The accounts 175 can include details about individual users, employees, and employers. For example, an individual user profile can include savings or checking accounts for salary deposits, investment accounts for managing returns or portfolios, and retirement accounts such as 401(k) plans. The attributes of such accounts 177 can include account types, balances, account statuses, or allocation percentages, and temporal attributes can include account opening dates, recent transaction dates, or historical allocation adjustments. An employer profile can include accounts 177, such as centralized payroll accounts for disbursement or investment accounts for managing corporate funds. The attributes of such accounts 177 can include balances, transaction histories, or account statuses, and temporal attributes can include recent deposit schedules, account creation dates, or historical fund transfers. A plan sponsor profile can include accounts 177 for managing plan assets, liabilities, or fee structures. The attributes of such accounts 177 can include account types, expense ratios, or investment options, and temporal attributes such as plan inception dates, recent account activity, or historical performance trends. The centralized storage of accounts 177 in the database 135 can allow for consistent application of data integrity and security protocols across all associated users or entities.

The accounts 177 can be associated with the profile data structures 176 through relationships or key constraints in the database 135. For example, an account 177 (e.g., savings, checking, investment, or retirement) associated with an individual can be associated with their profile data structure 176, and a payroll account associated with an employer can be associated with the company’s profile data structure 176. In a relational database, the accounts 177 can be stored in separate tables and associated with the profile data structure table using primary or foreign key relationships. For example, a user table can include user information, and an accounts table can include details for each account, with a key relationship associating the two tables. In a NoSQL database, the accounts 177 can be embedded within the profile data structure 176 or stored in separate collections and linked through document IDs or other reference mechanisms. For example, in a JSON document corresponding to a profile data structure 176, the corresponding account details can be embedded within the document itself, or the account details can be stored in a separate collection and referenced by an identifier.

The database 135 can store or maintain one or more source identifiers 178. The source identifier 178 can be an alphanumeric code or string that specifies an organization or entity from which an associated profile data structure 176 receives income or other financial benefits. The source identifier 178 can be used to track and manage financial data associated with specific sources, such as employer income, client payments, or project revenue. Each source identifier 178 can be unique or standardized to facilitate data exchange and processing. The source identifier 178 can specify various attributes, such as an employer ID associated with an employer (e.g., government agency or private organization), the official name of a company or organization, a client ID associated with a profile data structure 176, or project codes. The associated attributes can provide additional context and detail about the source of the income or benefits. The source identifier 178 can be used for various financial applications, such as payroll processing, financial reporting, tax preparation, and benefits administration, among others.

The database 135 can store or maintain one or more computing infrastructure identifiers 179. The computing infrastructure identifier 179 can be a code or string that specifies a financial institution or bank where an associated profile data structure 176 maintains an account 177. The computing infrastructure identifier 179 can be used to facilitate electronic transactions, data exchange, or payment processing. For example, the computing infrastructure identifier 179 can be used to identify or verify financial institutions involved in the operations. Each computing infrastructure identifier 179 can be unique and can be standardized to provide interoperability or secure communication. The computing infrastructure identifier 179 can include details such as bank routing numbers (e.g., which identify specific financial institutions), bank identification numbers (e.g., which are assigned by card networks to distinguish banks), bank account numbers (e.g., which specify individual accounts within a bank), or payment processor IDs (e.g., which are identifiers used to route transactions through payment gateways). The computing infrastructure identifier 179 can improve data accuracy by facilitating the identification of financial institutions and accounts in transaction workflows.

The system 100 can include, interface with, communicate with, or otherwise utilize a payroll processing system 120. The payroll processing system 120 can be or include any script, file, program, application, set of instructions, or computer-executable code that can be configured to execute an automatic repeating network operation, such as updating direct deposit allocations, adding or removing direct deposit accounts, or modifying direct deposit payment schedules, among others. The payroll processing system 120 can be internal to the data processing system 105. The payroll processing system 120 can exist external to the data processing system 105 and can be accessed via the network 110. The payroll processing system 120 can update the profile data structure 176 based on a plurality of interactions, such as modifying configurations for direct deposit operations. These configurations can include adjustments to numerical amounts or percentages allocated to one or more accounts 177 associated with corresponding computing infrastructure identifiers 179. For example, the payroll system 120 can split one or more paychecks into multiple payroll deposits and allocate portions of the payroll to different accounts, such as checking or savings accounts, according to allocation preferences stored in the profile data structure 176. In an aspect, the data processing system 105 can cause, upon receiving a confirmation from the client device 115, the payroll processing system 120 to update the configurations for the automatic repeating network operation.

The payroll processing system 120 can maintain a record of events or configurations associated with a profile data structure 176. The records can include details such as the allocation of payroll amounts to various accounts, changes to account configurations, updates to direct deposit schedules, or interactions involving computing infrastructure identifiers 179, such as bank routing and account numbers. The payroll processing system 120, or the data processing system 105, can facilitate a role-based access control to restrict access to sensitive information, such that authorized users can view or modify details related to direct deposit operations.

The payroll processing system 120 can execute network operations or computer instructions to manage payroll-related data, including updating direct deposit allocations or initiating payments based on updated configurations in the profile data structure 176. The network operations can cause the payroll processing system 120 to adjust the distribution of payroll funds across different accounts or modify schedules for recurring payments. The one or more computer instructions can refer to a set of executable commands that cause the payroll processing system 120, the data processing system 105, or any other computing systems to perform specific tasks, such as updating account details, recalibrating allocation percentages, or implementing changes to direct deposit preferences specified in the updated configurations. In some embodiments, the instructions can include input parameters used by the payroll processing system 120 to execute the commands. For example, an instruction to update direct deposit allocations for an employee (e.g., employee ID 12345) can include input parameters specifying new allocation percentages for one or more accounts 177. In an aspect, the input parameters may indicate, for example, a 70% allocation to a checking account associated with bank 1 and a 30% allocation to a savings account associated with bank 2.

The system 100 can include, interface with, communicate with, or otherwise utilize a payment gateway 125. The payment gateway 125 can be or include any script, file, program, application, set of instructions, or computer-executable code that can be configured to interface with computing infrastructures, such as banks or other financial institutions, to facilitate automated data exchange. The payment gateway 125 can establish encrypted connections with computing infrastructures using secure communication protocols, such as hypertext transfer protocol secure (HTTPS) or transport layer security (TLS), to protect sensitive financial data during transit. The payment gateway 125 can be configured to perform structured data extraction via application programming interfaces (APIs) provided by the computing infrastructure. For computing infrastructures without API support, the payment gateway 125 can implement web scraping techniques to retrieve relevant financial information directly from web interfaces, which can then be parsed using hypertext markup language (HTML) parsers or data extraction libraries to extract specific data elements.

The payment gateway 125 can process structured data (e.g., JSON, XML) or unstructured data (e.g., raw HTML, text files). The payment gateway 125 can map the extracted data to predefined schemas for integration with the profile data structure 176 or other system components. The payment gateway 125 can be configured to utilize various authentication techniques, such as OAuth or token-based authentication, to verify the identity of the user or application requesting data. The payment gateway 125 can implement retry logic or error handling to facilitate reliable operation in the event of transient network failures or mismatched data formats. The payment gateway 125 can maintain audit logs of data extraction activities, including timestamps, source identifiers, or changes made to the data.

The payment gateway 125 can cause the data processing system 105 or payroll processing system 120 to update the profile data structure 176. For example, the payment gateway 125 can receive a request from the client device 115, via the application interface 180, to update the profile data structure 176 with a new bank account 177. In response to receiving the request, the payment gateway 125 can validate the client device 115 by verifying authentication credentials, such as usernames, passwords, or multi-factor authentication tokens. The validation process can include checking session tokens, IP address whitelisting, or compliance with predefined security policies. The payment gateway 125 can communicate with the data processing system 105 or the payroll processing system 120 via a secure API connection or message queue system, using encrypted protocols such as HTTPS or TLS to maintain secure and reliable data exchange. The payroll processing system 120 can update the corresponding profile data structure 176 with the new bank account information, including details such as the account number, bank name, and routing number. Upon updating the profile data structure 176, the payment gateway 125 can provide a confirmation status to a user via the client device 115.

The system 100 is shown as including the data source 130, which can be accessible via the network 110. The data source 130 can be a computing system, server, data repository, or any other source of data that can store, provide, or otherwise maintain information relating to computing infrastructures or banking systems. The data source 130 can include hardware, software, or a combination thereof. The data source 130 can provide access to at least one of databases, APIs, or computing infrastructures to support its functionality. The data source 130 can be internal or external to the system 100 and can be accessed via network connections. The data source 130 can facilitate access to account information associated with banks or financial institutions where the profile data structure 176 has associated accounts 177. The data source 130 can utilize APIs to access and maintain data from external systems, such as bank APIs or financial data providers. In some embodiments, the data source 130 can implement web scraping techniques to retrieve and maintain the relevant information from financial systems. The data source 130 can include databases to store structured or unstructured data to facilitate efficient retrieval or analysis of account details, such as account numbers, routing numbers, balances, or transaction histories associated with one or more computing infrastructures. The data source 130 can integrate data from multiple sources, such as banks, credit card companies, or investment firms. The data source 130 can process and transform raw data into a usable format, including data cleaning, normalization, and enrichment. The data source 130 can implement security measures to protect sensitive financial information.

The data source 130 can function as a server or be associated with a server within a bank provider-specific computing system. The data source 130 can store and process information related to the accounts 177 associated with the profile data structure 176, such as the number of accounts currently associated, newly added accounts, or account types (e.g., savings or checking). In some embodiments, the data source 130 can support regular data feeds, such as daily or weekly updates, to provide real-time or near real-time synchronization of account details associated with the profile data structure 176. For example, the data source 130 can generate a feed for the data processing system 105, the payroll processing system 120, or the payment gateway 125, indicating that new accounts, such as a savings account and a checking account, have been added to the profile data structure 176, along with their corresponding account identifiers and the associated computing infrastructure identifiers, such as the bank routing number and institution name.

The data processing system 105 can include, interface with, communicate with, or otherwise utilize a system processor 140. The system processor 140 can be or include any script, file, program, application, set of instructions, or computer-executable code that can be configured to execute one or more instructions associated with the data processing system 105. The system processor 140 can include an electronic processor, an integrated circuit, or the like, including one or more of digital logic, analog logic, digital sensors, analog sensors, communication buses, volatile memory, nonvolatile memory, and the like. The system processor 140 can include, but is not limited to, at least one microcontroller unit (MCU), microprocessor unit (MPU), central processing unit (CPU), graphics processing unit (GPU), physics processing unit (PPU), embedded controller (EC), or the like. The system processor 140 can include a memory operable to store one or more instructions for operating components of the system processor 140 and operating components operably coupled to the system processor 140. For example, the one or more instructions can include one or more of firmware, software, hardware, operating systems, or embedded operating systems. The system processor 140 or the data processing system 105 generally can include one or more communication bus controllers to effect communication between the system processor 140 and the other elements of the data processing system 105.

The data processing system 105 can include, interface with, communicate with, or otherwise utilize an interface controller 145. The interface controller 145 can be or include any script, file, program, application, set of instructions, or computer-executable code that can be configured to facilitate communication among the data processing system 105, the client system 115, the payroll processing system 120, the payment gateway 125, and the data source 130. The interface controller 145 can include hardware, software, or any combination thereof. The interface controller 145 can facilitate communication among the data processing system 105, the client system 115, the payroll processing system 120, the payment gateway 125, and the data source 130 via one or more communication interfaces. A communication interface can include, for example, an application programming interface (“API”) compatible with a particular component of the data processing system 105, the client system 115, the payroll processing system 120, the payment gateway 125, and the data source 130. The communication interface can provide a particular communication protocol compatible with a particular component of the data processing system 105, a particular component of the client system 115, a particular component of the payroll processing system 120, a particular component of the payment gateway 125, or a particular component of the data source 130. The interface controller 145 can be compatible with particular content objects and can be compatible with particular content delivery systems corresponding to particular content objects, structures of data, types of data, or any combination thereof. For example, the interface controller 145 can be compatible with the transmission of structured or unstructured data according to one or more metrics.

The data processing system 105 can include, interface with, communicate with, or otherwise utilize a request receiver 150. The request receiver 150 can be or include any script, file, program, application, set of instructions, or computer-executable code that can be configured to receive requests from client devices 115. The request receiver 150 can listen for incoming requests over network protocols and process various types of requests, including user logins, data queries, and transaction requests. The request receiver 150 can process various network protocols, including hypertext transfer protocol (HTTP) or HTTP secure (HTTPS) for standard web communication, representational state transfer (REST) APIs for web services, simple object access protocol (SOAP) for XML-based requests and response, websockets for real-time, full-duplex communication, message queues such as those for asynchronous processing and high-throughput scenarios, remote procedure call (RPC) frameworks such as general RPC (GRPC) and XML-based RPC, transmission control protocol (TCP) and user datagram protocol (UDP) sockets for data transmission, GraphQL for flexible, query-based data retrieval, and file transfer protocol (FTP) or secure file transfer protocol (SFTP) for file uploads and processing, among others.

The request receiver 150 can cause other components within the data processing system 105 to perform authentication or authorization functions, or implement these functions itself, such as using OAuth to establish secure authorization, facilitating the client devices 115 to grant access or limited access to the user’s data without sharing credentials. The request receiver 150 can manage one or more API tokens configured to establish secure communication with at least one of a client device 115, a payment gateway 125, or a data source 130. In some embodiments, the request receiver 150 can process requests based on data retrieved by the payment gateway 125 or data sources 130, where the data includes information related to computing infrastructures, such as details about current or newly associated bank accounts or other relevant bank provider information. The request receiver 150 can facilitate secure communication channels by implementing encryption standards, such as transport layer security (TLS) or secure sockets layer (SSL) to protect the integrity and confidentiality of transmitted data. The request receiver 150 can process the request and forward the received data to the appropriate component within the data processing system 105 for further processing.

The request receiver 150 can identify a profile data structure 176 associated with the requesting client device 115 using various techniques. For session-based identification, the request receiver 150 can receive or generate a session ID when a client device 115 initiates a session. The request receiver 150 can store the session ID on the server side or the database 135 and associate the session ID with the corresponding profile data structure 176. Subsequent requests from the same client device 115 can include the session ID, allowing the request receiver 150 to identify the correct profile and validate the request. In some embodiments, token-based identification can include the client device 115, including an API token with each request, which the request receiver 150 verifies or causes another component within the data processing system 105 to verify and identify the associated profile. In some embodiments, user credentials such as a username and password can be used, where the request receiver 150 compares the credentials with the profile data structure 176 maintained in the database 135 to identify and authenticate the user.

The data processing system 105 can include, interface with, communicate with, or otherwise utilize a query engine 155. The query engine 155 can be or include any script, file, program, application, set of instructions, or computer-executable code that can be configured to retrieve relevant data from the database 135 based on network requests received from the request receiver 150. The query engine 155 can process requests by using the profile data structure 176 associated with the corresponding request to query the database 135 and retrieve multiple source identifiers 178 and corresponding computing infrastructure identifiers 179. Each source identifier 178 can represent an entity, such as an employer, and can be associated with a corresponding computing infrastructure identifier 179, such as a bank. The query engine 155 can implement techniques such as indexing, query optimization, or caching to enhance efficiency.

The query engine 155 can process requests by extracting parameters, such as user IDs or account types, from the request and executing a structured query to retrieve relevant data from the database 135. For example, if a client device 115 transmits a request to view bank account information, the query engine 155 can extract the user ID and account type (e.g., checking or savings) from the request, construct an SQL query to retrieve the relevant data, send the query to the database 135 for execution, and format the retrieved results, such as account numbers, balances, or transaction history associated with the profile data structure 176, in a suitable format (e.g., JSON or XML) for the client system 115 or other components of the system 100 for further processing.

The query engine 155, via the data processing system 105, can cause the client device 115 to present a user interface that includes one or more interface objects, such as tabs or menus, for displaying the data retrieved from the database 135. The interface object can correspond to each of the multiple source identifiers 178 and can be configured to display settings for the automatic repeating network operation associated with the respective source identifier 178. These settings can include direct deposit allocations defining the distribution of funds among one or more bank accounts, direct deposit payment schedules specifying the frequency and timing of direct deposit payments, and other customizable parameters specific to the source identifier 178. The interface object can include interactive elements, allowing the user to view, modify, or add new configurations via the client device 115. The data processing system 105 can receive requests from the client device 115 in response to user interactions with the interactive elements and execute one or more components of the data processing system 105.

The data processing system 105 can include, interface with, communicate with, or otherwise utilize a partial switch operator 160. The partial switch operator 160 can be or include any script, file, program, application, set of instructions, or computer-executable code that can be configured to receive and process multiple interactions related to partial switches for automatic repeating network operations. Partial switches for automatic repeating network operations can refer to modifications or adjustments made to specific components or parameters within a recurring network operation rather than replacing or reconfiguring the entire operation. Partial switches can provide targeted updates to configurations, allocation preferences, or execution parameters. For example, a partial switch can include updating allocation percentages across multiple accounts without altering other predefined settings in the repeating network operation. Additionally, the partial switches can include adjusting specific resources, schedules, or rules within an automated process to maintain compliance with changing requirements.

The partial switch operator 160 can receive interactions related to automating, setting, or modifying the allocation of direct deposit funds among various accounts 177 or at least two accounts 177 associated with multiple source identifiers 178 and corresponding computing infrastructure identifiers 179. The partial switch operator 160 can convert interactions, such as user-initiated requests or periodic updates received from one or more data sources 130, into executable commands to execute actions. The actions can initiate the partial switches via the data processing system 105 or other system components, such as a payroll processing system 120. The partial switch operator 160 can generate SQL statements to update records in the database 135, such as modifying direct deposit allocations between different accounts 177 associated with the profile data structure 176. The partial switch operator 160 can generate API calls to trigger actions in external systems, such as updating direct deposit settings in the payroll processing system 120 or initiating transfers, via the payment gateway 125, between multiple accounts 177 associated with corresponding computing infrastructure identifiers 179. The partial switch operator 160 can process rules stored in configuration files, such as JSON or XML, and generate executable commands to update direct deposit allocations. The partial switch operator 160 can utilize applications, web or mobile interfaces, or integrated microservices communicating via APIs to transform rules or received interactions into operational directives to execute actions.

The partial switch operator 160 can execute batch processing instructions to process multiple interactions and generate one or more executable commands that cover such interactions. For example, when a user initiates, via the client device 115, several changes to direct deposit allocations across multiple accounts, the partial switch operator 160 can group the interactions into a single batch and generate a corresponding set of executable commands. For example, a user, via the client device 115 or the payment gateway 125, can implement several changes to their direct deposit allocations, such as increasing the allocation to their savings account, decreasing the allocation to their checking account, and adding a new direct deposit account, among others. The partial switch operator 160 can generate commands for the data processing system 105 or the payroll processing system 120 to update the savings account allocation, update the checking account allocation, and insert the new account into the database 135. The commands can be executed in sequence or simultaneously, depending on the implementation.

The partial switch operator 160 can implement workflow automation tools to manage updates to direct deposit allocations in response to detecting, via the data sources 130 or the payment gateway 125, an account that is not associated with the profile data structure 176. The partial switch operator 160 can define workflows that specify a sequence of tasks, such as retrieving allocation rules, processing direct deposit data, and preparing instructions for the client device 115 associated with the profile data structure 176. The workflows can be triggered whenever new accounts are associated with the profile data structure 176, such that direct deposit allocations are updated based on predefined rules or account-specific preferences. For example, when an account is created by a user with a computing infrastructure not already stored in the database 135, the partial switch operator 160 can automatically update allocation percentages and provide a notification, via a notification generator 170, to the client device 115 for the user to confirm the allocation changes. In response to receiving confirmation from the client device 115, the partial switch operator 160 can cause, via the data processing system 105, the payroll processing system 120 to update the corresponding profile data structure 176.

The partial switch operator 160 can generate payment instructions for a computing infrastructure identifier 179 in response to identifying that its corresponding account 177 has been associated with the profile data structure 176. When a new account, such as a bank account, is associated with the profile data structure 176, the payroll processing system 120 can update the profile data structure 176 with relevant details, such as the account number, bank name, routing number, and other metadata. Upon detecting this update, the partial switch operator 160 can retrieve the account information, including the account number, routing number, and associated identifiers that associate the account 177 with the corresponding bank or financial institution. The payment instructions can include details such as recipient information (bank or payment processor), account information (account number, bank name, routing number), payment amount (dynamic or predefined), transaction type (e.g., deposit or transfer), and authorization information for secure processing. The partial switch operator 160 can also incorporate rewards programs or financial incentives, such as bonuses or cashbacks, into the payment instructions. For example, a reward program associated with account 177 can trigger a reward payment upon successful account association or transaction. Upon generating the payment instructions, the partial switch operator 160 can cause the data processing system 105, the payroll processing system 120, or the payment gateway 125, depending on the implementation, to execute the payment instructions for the corresponding computing infrastructure identifier 179.

The data processing system 105 can include, interface with, communicate with, or otherwise utilize a security manager 165. The security manager 165 can be or include any script, file, program, application, set of instructions, or computer-executable code that can be configured to facilitate secure communications, data protection, or system reliability. The security manager 165 can generate, utilize, or maintain API tokens to authenticate and authorize requests from client devices 115 and other systems, such as the payment gateway 125 or the data sources 130. The security manager 165 can generate or manage API tokens for different client devices 115 or services, assigning specific permissions, such as read-only or read-write access. The security manager 165 can distribute tokens to authorized client devices 115 or other systems via secure communication channels or encrypted storage. The security manager 165 can validate API tokens by checking the validity, expiration date, and associated permissions in response to receiving a request from the client device 115 or other systems. In some embodiments, the security manager 165 can implement token rotation policies by periodically generating new tokens and revoking old ones. For example, when the client device 115, via the application interface 180, requests access to the account information associated with the profile data structure 176, the client device 115 can transmit a request to the data processing system 105 with an API token. The security manager 165 can verify the API token’s validity and the client device’s authorization level. For example, if the token is valid, the data processing system 105 can provide the relevant details to the client device 115.

The security manager 165 can utilize OAuth to establish secure authorization protocols, allowing authorized users or systems to access specific resources via the payment gateway 125. The client device 115, via the application, can redirect the user to the system’s authorization server. The user can authenticate the client device 115 by providing credentials (e.g., username and password), via the application interface 180, to the authorization server. Upon successful authentication and authorization, the authorization server can issue an access token to the client device 115. The security manager 165 can facilitate the interaction between the authorization server and the client device 115. The client device 115 can utilize the access token to make authenticated API calls to the payment gateway 125. The payment gateway 125 can validate the access token and, via the data processing system 105, retrieve details associated with the corresponding profile data structure 176.

The security manager 165 can generate or track session identifiers to manage updates to configurations for the automatic repeating network operation. The security manager can track session identifiers to manage user sessions or prevent unauthorized access. The security manager 165 can utilize phone-based proofing or one-time passcodes to verify user identity during enrollment or modification processes. The security manager 165 can implement data validation techniques, such that the profile data structure 176 is updated accurately. For example, the security manager 165 can implement data type validation (e.g., verifying that data entered into the system conforms to the expected data types, such as numeric, string, or date), range validation (e.g., confirming that deposit amounts fall within a predefined acceptable range), or format validation (e.g., verifying the format of email addresses, phone numbers, or account numbers).

The security manager 165 can facilitate data normalization by breaking down data into smaller, more specific pieces to reduce redundancy and improve data integrity. The security manager 165 can implement encryption, access controls, and regular security audits to protect sensitive information, such as personally identifiable information. The security manager 165 can implement data privacy regulations, such as GDPR (General Data Protection Regulation), to protect personal data, including establishing data retention policies to define how long data is stored and when it should be deleted or anonymized. The security manager 165 can facilitate error handling or recovery in case of system failures or disasters. For example, the security manager 165 can log errors and system events to facilitate troubleshooting and incident response.

The data processing system 105 can include, interface with, communicate with, or otherwise utilize a notification generator 170. The notification generator 170 can be or include any script, file, program, application, set of instructions, or computer-executable code that can be configured to generate and transmit notifications to client devices 115 based on specific events or triggers. The notification generator 170 can transmit notifications to notify users about events such as the successful association of an account 177 with the profile data structure 176, changes in deposit allocation across different accounts, updates to the account details, or instructions on confirming changes. The notification generator 170 can present relevant details, such as the source identifier 178, computing infrastructure identifier 179, account numbers, or updated allocation breakdown. The notification generator 170 can determine the client device 115 that is to receive the notification via the profile data structure 176 associated with the client device 115. The profile data structure 176 can specify the user’s preferred notification channels, such as push notifications, emails, or in-app messages, with notifications transmitted via APIs to the appropriate channel. The notification generator 170 can format the notification based on the user’s preferences or the specific context of the notification, such that the notification is clear, relevant, and appropriately timed.

The data processing system 105 can include, interface with, communicate with, or otherwise utilize an operation controller 175. The operation controller 175 can be or include any script, file, program, application, set of instructions, or computer-executable code that can be configured to manage or execute actions associated with one or more components of the data processing system 105, the client system 115, the payroll processing system 120, the payment gateway 125, or the data sources 130. The operation controller 175 can define and manage workflows comprised of multiple interconnected tasks. The operation controller 175 can initiate, monitor, and control the execution of workflow steps. The operation controller 175 can implement conditional logic for dynamic workflow routing. The operation controller 175 can execute multiple tasks concurrently through parallel processing, where data preprocessing can occur at the source (e.g., client servers, data entry points) using distributed edge computing technologies. The operation controller 175 can implement error handling and recovery mechanisms for workflow exceptions. The operation controller 175 can track workflow progress and provide status updates. For example, the operation controller 175 can include one or more interfaces to detect input at various portions of a workflow and can provide output responsive to specific portions of a workflow.

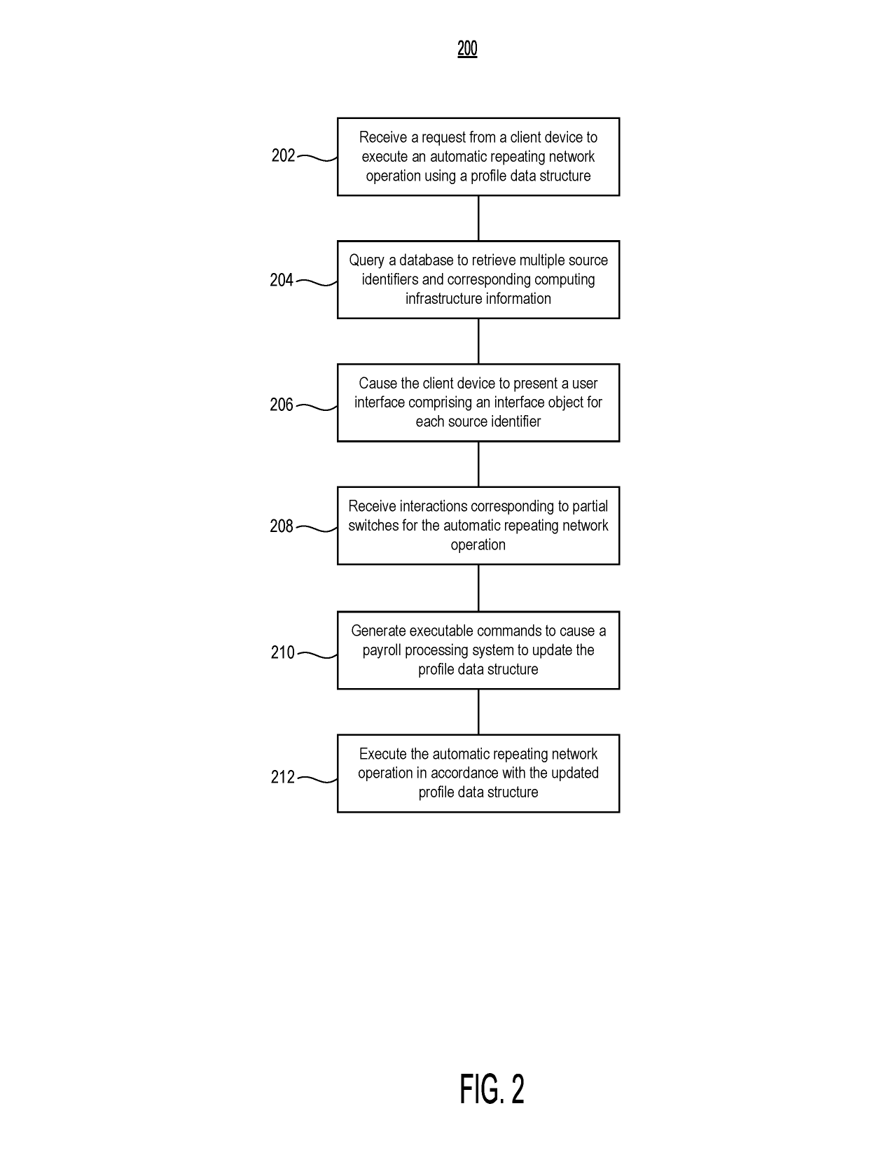

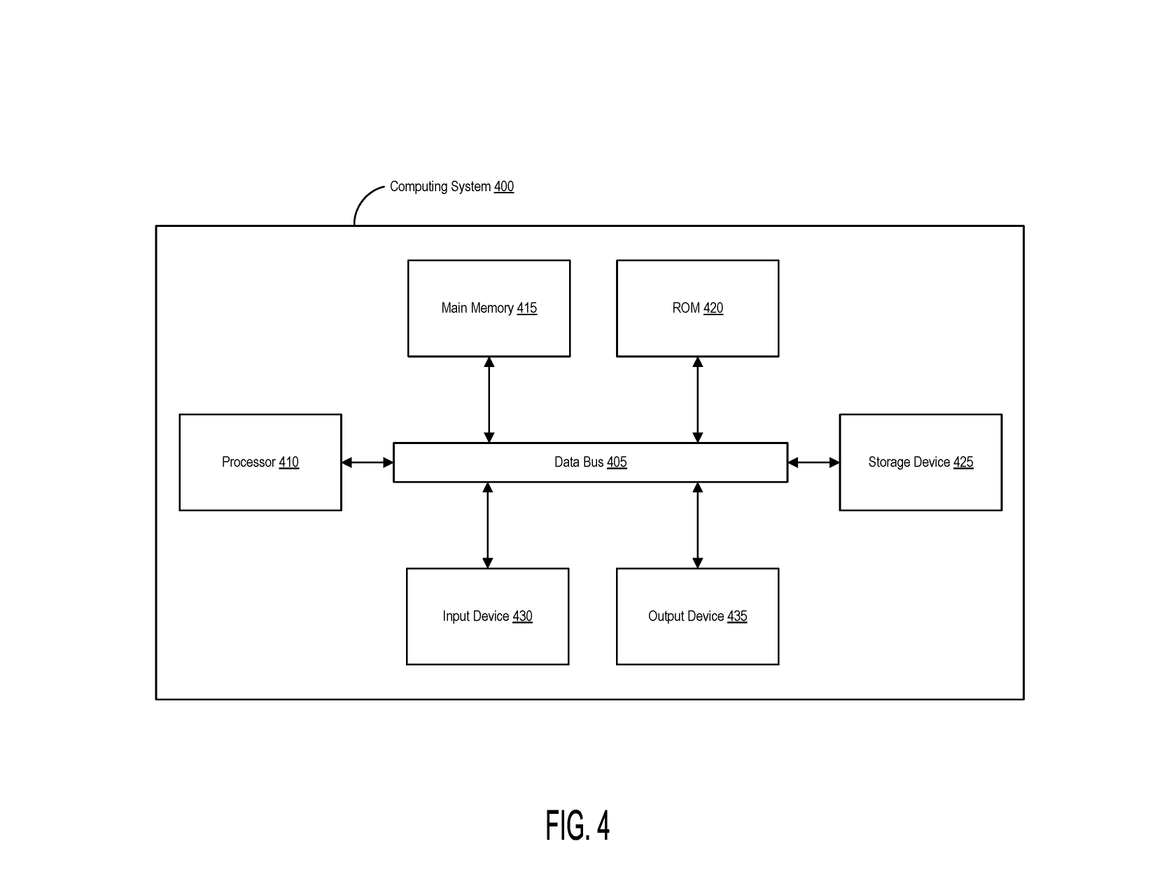

FIG. 2 depicts a method 200 of automatic repeating network operation execution using partial switches. The method 200 can be implemented using a system 100, 400, or any other features discussed in FIG. 1 or FIG. 4. The method can include Acts 202‒212. The Acts 202‒212 can be executed in any order or sequence.

At 202, the method 200 can receive a request from a client device to execute an automatic repeating network operation using a profile data structure. In an aspect, the method can include receiving the request to execute the automatic repeating network operation using the profile data structure associated with the client device. In another aspect, the method can include generating one or more application programming interface (API) tokens configured to establish secure communication with at least one of a client device or a gateway. In another aspect, the method can include receiving a request based on data retrieved by the gateway from data sources, where the data sources can include at least one of databases, APIs, or computing infrastructures. In another aspect, the method can include generating a session identifier to track updates to the configurations for the automatic repeating network operation.

At 204, the method 200 can query a database to retrieve multiple source identifiers and corresponding computing infrastructure information. In an aspect, the method can include querying, using the profile data structure, the database to retrieve multiple source identifiers and corresponding computing infrastructure information. In another aspect, the method can include querying the database based on the profile data structure and the data retrieved by the gateway. The corresponding computing infrastructure information can include one or more electronic accounts. Each electronic account can include a routing number and an account number associated with a corresponding computing infrastructure identifier. Each electronic account can be at least one of a savings account, a checking account, an investment account, or a retirement account.

At 206, the method 200 can cause the client device to present a user interface comprising an interface object for each source identifier. In an aspect, the method can include causing the client device to present an interface object for each of the multiple source identifiers. The interface object can be configured to display configurations for the automatic repeating network operation associated with a respective source identifier. In another aspect, the method can include causing each of the interface objects to present an interactive element that, when interacted with, initiate actions to execute partial switches.

At 208, the method 200 can receive interactions corresponding to partial switches for the automatic repeating network operation. In an aspect, the method can include receiving, from the client device, a plurality of interactions corresponding to partial switches for the automatic repeating network operation for at least two of the multiple source identifiers.

At 210, the method 200 can generate executable commands to cause a payroll processing system to update the profile data structure. In an aspect, the method can include generating one or more executable commands to cause the payroll processing system to update the profile data structure based on the plurality of interactions. In another aspect, the method can include causing, in response to receiving the plurality of interactions corresponding to the partial switches for the automatic repeating network operation, the payroll processing system to modify an allocation of direct deposit amounts to one or more electronic accounts associated with a corresponding computing infrastructure identifier. In another aspect, the method can include causing the payroll processing system to allocate the direct deposit amounts based on a numerical amount or a percentage. In another aspect, the method can include causing, upon receiving a confirmation from the client device, the payroll processing system to update the configurations for the automatic repeating network operation. The configurations can include at least one of updating direct deposit allocations, adding or removing direct deposit accounts, or modifying direct deposit payment schedules.

At 212, the method 200 can execute the automatic repeating network operation in accordance with the updated profile data structure. In an aspect, the method can include executing an operation upon updating the profile data structure, where the operation can include generating payment instructions for a corresponding computing infrastructure identifier. In another aspect, the method can include utilizing OAuth to establish secure authorization for executing the automatic repeating network operation associated with the profile data structure.

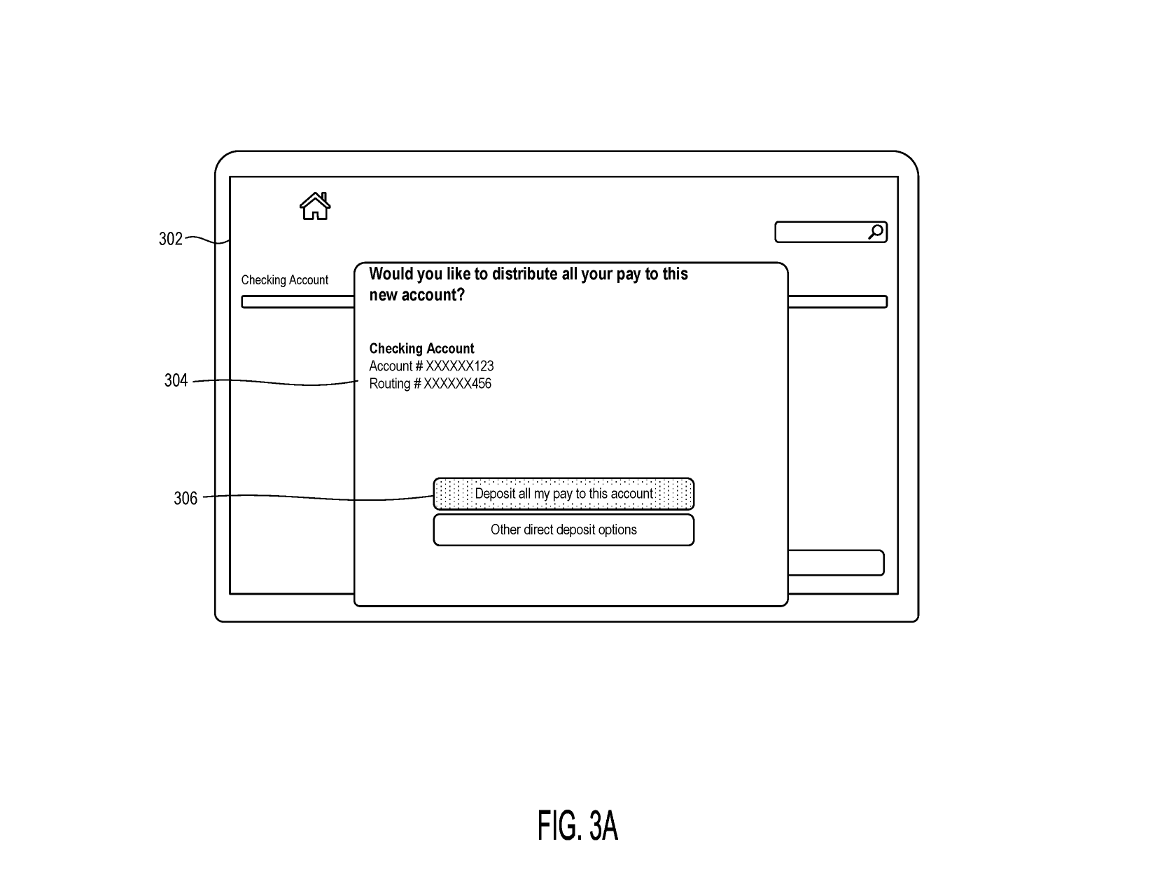

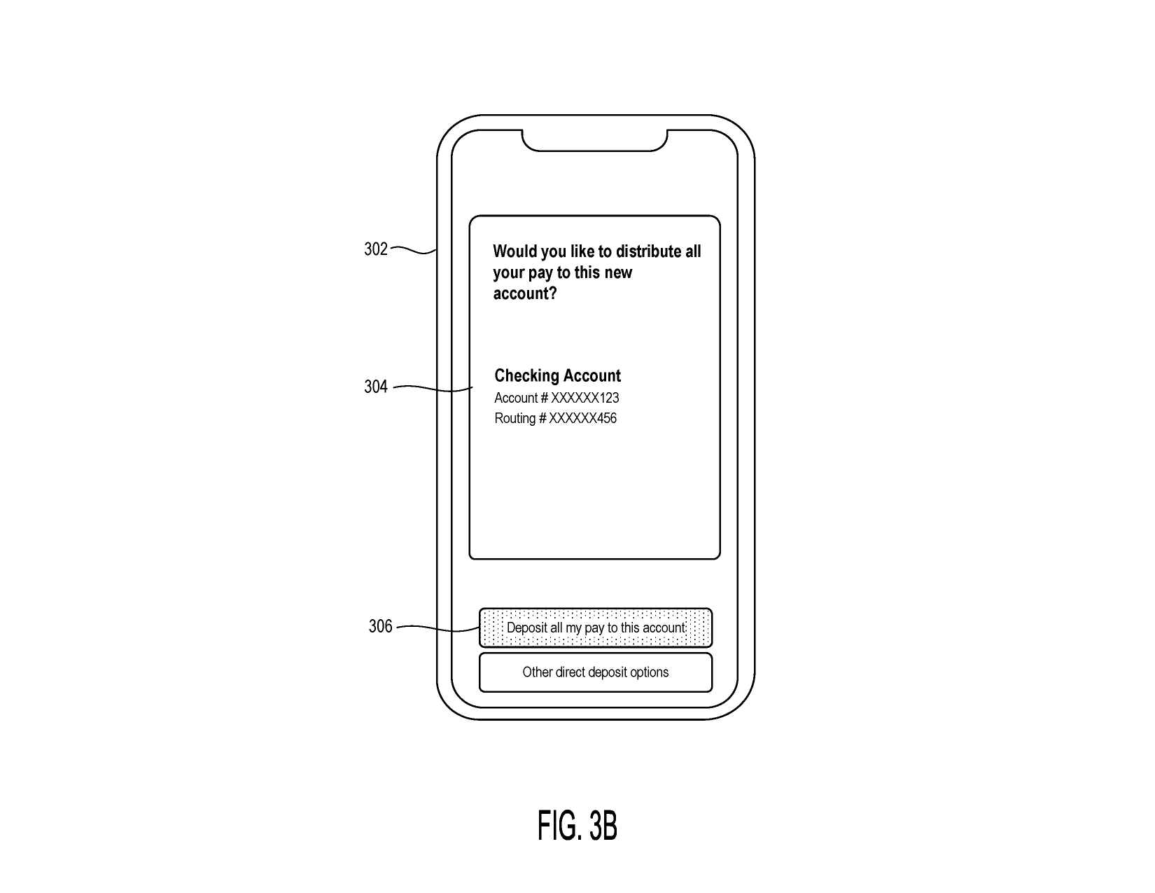

FIGS. 3A-3B depict an example user interface 302, as described in connection with FIGS. 1-2. FIG. 3A illustrates a web-based user interface 302 configured to facilitate partial switching operations across multiple accounts. FIG. 3B illustrates a mobile user interface 302 configured to provide similar functionalities in a mobile-optimized format. The user interface 302 can be integrated with payment gateways 125 or data sources 130, including bank servers, to dynamically retrieve and display account information or updated details, such as those for newly added computing infrastructure identifiers 179. In an aspect, the integration can utilize APIs provided by the data processing system 105, the payment gateways 125, or the data sources 130 to facilitate secure communication and data exchange. The user interface 302 can send requests and receive responses related to payment transactions and account information via APIs. In another aspect, the data processing system 105 can facilitate secure authentication and authorization techniques, such as OAuth or API keys, such that authorized users and systems access the payment gateways 125 and data sources 130.

The user interface 302 can include one or more interface objects 304, each configured to present configurations associated with source identifiers 179 and corresponding computing infrastructure identifiers 179. For example, the user interface 302 can be configured to allow users to view and manage configurations for multiple source identifiers 178 through respective interface objects 304 presented within a unified user interface 302. Each interface object 304 can display various account types, such as savings accounts or checking accounts, and provide details for each account. For example, each interface object 304 can display account-specific information, such as the account type (e.g., savings or checking), account number, and routing number. The interface objects 304 can present additional details, such as allocation preferences. For example, the interface object 304 displaying a checking account can be configured to present various allocation options, including full deposit amount, a specific numerical value, or a percentage of the total deposit across one or more accounts.

Each interface object 304 can present interactive elements 306 that, when interacted with, cause the data processing system 105 or the payroll processing system 120 to execute specific actions related to direct deposit configurations. For example, when a user interacts with an interactive element 306, such as selecting “Deposit all my pay to this account,” the data processing system 105 can process the request received from the client device 115 and cause the payroll processing system 120 to update the profile data structure 176. The payroll processing system 120 can facilitate the allocation of the entire paycheck to the specified account. Additionally, the interface object 304 can present other interactive elements 306, such as “Other direct deposit options,” which update the interface object 304 to display alternative allocation preferences. In an aspect, when a user interacts with “Other direct deposit options,” the data processing system 105 can process the request received from the client device 115, depending on the interaction, and execute specific actions, such as initiating partial switches or other updates to the profile data structure 176. It is to be noted that FIGS. 3A-3B provide non-limiting examples of user interfaces and may include or present other functionalities, as described in connection with FIGS. 1-2.

FIG. 4 depicts a block diagram of a computing system 400 for implementing the embodiments of the technical solutions discussed herein, in accordance with various aspects. FIG. 4 illustrates a block diagram of an example computing system 400, which can also be referred to as the computer system 400. Computing system 400 can be used to implement elements of the systems and methods described and illustrated herein. Computing system 400 can be included in and run any device (e.g., a server, a computer, a cloud computing environment, or a data processing system).

Computing system 400 can include at least one bus data bus 405 or other communication device, structure or component for communicating information or data. Computing system 400 can include at least one processor 410 or processing circuit coupled to the data bus 405 for executing instructions or processing data or information. Computing system 400 can include one or more processors 410 or processing circuits coupled to the data bus 405 for exchanging or processing data or information along with other computing systems 400. Computing system 400 can include one or more main memories 415, such as a random access memory (RAM), dynamic RAM (DRAM), cache memory or other dynamic storage device, which can be coupled to the data bus 405 for storing information, data and instructions to be executed by the processor(s) 410. Main memory 415 can be used for storing information (e.g., data, computer code, commands, or instructions) during execution of instructions by the processor(s) 410.

Computing system 400 can include one or more read only memories (ROMs) 420 or other static storage device 425 coupled to the bus 405 for storing static information and instructions for the processor(s) 410. Storage devices 425 can include any storage device, such as a solid-state device, magnetic disk, or optical disk, which can be coupled to the data bus 405 to persistently store information and instructions.

Computing system 400 can be coupled via the data bus 405 to one or more output devices 435, such as speakers or displays (e.g., liquid crystal display or active matrix display) for displaying or providing information to a user. Input devices 430, such as keyboards, touch screens or voice interfaces, can be coupled to the data bus 405 for communicating information and commands to the processor(s) 410. Input device 430 can include, for example, a touch screen display (e.g., output device 435). Input device 430 can include a cursor control, such as a mouse, a trackball, or cursor direction keys, for communicating direction information and command selections to the processor(s) 410 for controlling cursor movement on a display.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors 410 in a multi-processing arrangement can also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter, including the operations described in this specification, can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
receive, from a client device, a request to execute an automatic repeating network operation using a profile data structure associated with the client device;
query, using the profile data structure, a database to retrieve multiple source identifiers and corresponding computing infrastructure identifiers, wherein each source identifier is associated with a computing infrastructure identifier for the automatic repeating network operation;
cause the client device to present a user interface comprising an interface object for each of the multiple source identifiers, the interface object configured to display configurations for the automatic repeating network operation associated with a respective source identifier;
receive, from the client device, a plurality of interactions corresponding to partial switches for the automatic repeating network operation for at least two of the multiple source identifiers;
generate one or more executable commands to cause a payroll processing system to update the profile data structure based on the plurality of interactions; and
execute the automatic repeating network operation in accordance with the updated profile data structure.

2. The system of claim 1, wherein the profile data structure is associated with one or more accounts maintained in the database, wherein each account comprises a routing number and an account number associated with the corresponding computing infrastructure identifiers.

3. The system of claim 1, wherein each account is at least one of a savings account, a checking account, an investment account, or a retirement account.

4. The system of claim 1, wherein the one or more processors are further configured to cause, upon receiving a confirmation from the client device, the payroll processing system to update the configurations for the automatic repeating network operation, the configurations comprising at least one of updating direct deposit allocations, adding or removing direct deposit accounts, or modifying direct deposit payment schedules.

5. The system of claim 1, wherein, in response to receipt of the plurality of interactions corresponding to the partial switches for the automatic repeating network operation, the one or more processors are further configured to cause the payroll processing system to modify an allocation of direct deposit amounts to one or more accounts associated with the corresponding computing infrastructure identifiers.

6. The system of claim 5, wherein the one or more processors are further configured to cause the payroll processing system to allocate the direct deposit amounts based on a numerical amount.

7. The system of claim 5, wherein the one or more processors are further configured to cause the payroll processing system to allocate the direct deposit amounts based on a percentage.

8. The system of claim 1, wherein the one or more processors are further configured to utilize OAuth to establish secure authorization, the OAuth causing execution of the automatic repeating network operation associated with the profile data structure.

9. The system of claim 1, wherein the one or more processors are further configured to generate one or more application programming interface (API) tokens configured to establish secure communication with at least one of a client device or a gateway.

10. The system of claim 1, wherein the one or more processors are further configured to cause each of the interface objects to present an interactive element that, when interacted with, causes the one or more processors to execute actions, the actions comprising initiating the partial switches.

11. The system of claim 1, wherein the one or more processors are further configured to generate a session identifier to track updates to the configurations for the automatic repeating network operation.

12. The system of claim 1, wherein the one or more processors are further configured to execute an operation upon updating the profile data structure, the operation comprising generating payment instructions for the corresponding computing infrastructure identifiers.

13. A method, comprising:
receiving, from a client device, a request to execute an automatic repeating network operation using a profile data structure associated with the client device;
querying, using the profile data structure, a database to retrieve multiple source identifiers and corresponding computing infrastructure information, the corresponding computing infrastructure information comprising one or more electronic accounts;
causing the client device to present a user interface comprising an interface object for each of the multiple source identifiers, the interface object configured to display configurations for the automatic repeating network operation associated with a respective source identifier;
receiving, from the client device, a plurality of interactions corresponding to partial switches for the automatic repeating network operation for at least two of the multiple source identifiers;
generating one or more executable commands to cause a payroll processing system to update the profile data structure based on the plurality of interactions; and
executing the automatic repeating network operation in accordance with the updated profile data structure.

14. The method of claim 13, wherein each electronic account comprises a routing number and an account number associated with a corresponding computing infrastructure identifier.

15. The method of claim 14, wherein each electronic account is at least one of a savings account, a checking account, an investment account, or a retirement account.

16. The method of claim 13, further comprising:
causing, upon receiving a confirmation from the client device, the payroll processing system to update the configurations for the automatic repeating network operation, the configurations comprising at least one of updating direct deposit allocations, adding or removing direct deposit accounts, or modifying direct deposit payment schedules.

17. The method of claim 13, wherein, in response to receiving the plurality of interactions corresponding to the partial switches for the automatic repeating network operation, further comprising:
causing the payroll processing system to modify an allocation of direct deposit amounts to one or more electronic accounts associated with a corresponding computing infrastructure identifier.

18. The method of claim 17, further comprising:
causing the payroll processing system to allocate the direct deposit amounts based on a numerical amount or a percentage.

19. The method of claim 13, further comprising:
utilizing OAuth to establish secure authorization, the OAuth causing execution of the automatic repeating network operation associated with the profile data structure.

20. A non-transitory computer readable medium including one or more instructions stored thereon and executable by a processor to:
receive, from a client device, a request to execute an automatic repeating network operation using a profile data structure associated with the client device, the request based on data retrieved by a gateway from data sources, the data sources comprising at least one of databases, APIs, or computing infrastructures;
query, based on the profile data structure and the data retrieved by the gateway, a database to retrieve multiple source identifiers and corresponding computing infrastructure identifiers;
cause the client device to present a user interface comprising an interface object for each of the multiple source identifiers, the interface object configured to display configurations for the automatic repeating network operation associated with a respective source identifier;
receive, from the client device, a plurality of interactions corresponding to partial switches for the automatic repeating network operation for at least two of the multiple source identifiers;
generate one or more executable commands to cause a payroll processing system to update the profile data structure based on the plurality of interactions; and
execute the automatic repeating network operation in accordance with the updated profile data structure.
